(19) United States
(12) Patent Application Publication
(10) Pub. No.: US 2025/0023135 A1
(43) Pub. Date: Jan. 16, 2025

(54) CONTROL DEVICE AND BATTERY MODULE

(71) Applicant: Ningde Amperex Technology Limited, Ningde (CN)

(72) Inventors: Lu WANG, Ningde (CN); Haoyu LI, Ningde (CN)

(73) Assignee: Ningde Amperex Technology Limited, Ningde (CN)

(21) Appl. No.: 18/901,226

(22) Filed: Sep. 30, 2024

Related U.S. Application Data
(63) Continuation of application No. PCT/CN2022/084188, filed on Mar. 30, 2022.

(51) Int. Cl. H01M 10/63; H01M 10/613; H01M 10/6563; H01M 10/663; H01M 50/204; H01M 50/55

(52) U.S. Cl. CPC H01M 10/63; H01M 10/613; H01M 10/6563; H01M 10/663; H01M 50/204; H01M 50/55

(57) ABSTRACT

A control device includes a first housing, a first control module, a first conductive path, a second conductive path, a first switch, and a first control member. The first housing includes a first recess. The first control module is close to a first wall. The first control module performs a corresponding control based on a status of an electrically connected battery. The first conductive path is contiguous to the first wall. The second conductive path is contiguous to the first wall. The first switch is contiguous to and electrically connected to the first conductive path and the second conductive path. When viewed along a first direction, the first switch and the first control module are spaced apart from each other. The first control member is outside the first housing. The first control member is connected to the first switch and controls closing and opening of the first switch.

### CROSS REFERENCE TO THE RELATED APPLICATIONS

This application is a continuation application of International Application No. PCT/CN2022/084188, filed on Mar. 30, 2022, the content of which is incorporated herein by reference in its entirety.

### TECHNICAL FIELD

This application relates to the technical field of high-voltage distribution boxes, and in particular, to a control device and a battery module.

### BACKGROUND

In recent years, energy storage technology has been developing continuously, giving rise to a continuous increase in the demand for energy storage products in domestic and international markets, and demonstrating a degree of economic viability in some fields. Currently, the development of global energy storage technology is mainly concentrated in the field of electrochemical energy storage. Lithium-ion batteries are widely used as an efficient, clean, and highly recyclable energy source. High-voltage distribution boxes are an important part of an energy storage system in normal operation. Conventional high-voltage distribution boxes incur problems such as a low space utilization rate, deficiency of modular design, and low maintainability and compatibility.

### SUMMARY

In view of the above situation, it is necessary to provide a control device designed in a modular manner to improve the space efficiency of a high-voltage distribution box and improve maintainability.

An embodiment of this application provides a control device. The control device includes a first housing, a first control module, a first conductive path, a second conductive path, a first switch, and a first control member. The first housing includes a first recess. The first housing includes a first wall, a second wall, and a bottom wall. The first wall is disposed opposite to the second wall. The bottom wall is connected to the first wall and the second wall. The first wall, the second wall, and the bottom wall constitute some inner walls of the first recess. The first control module is disposed in the first recess. When viewed along a first direction perpendicular to the bottom wall, the first control module is disposed between the first wall and the second wall. The first control module is closer to the first wall than to the second wall. The first control module is configured to perform a corresponding control based on a status of an electrically connected battery. The first conductive path is disposed in the first recess extends along a second direction perpendicular to the first direction. The first conductive path is contiguous to the first wall. The first wall is opposite to the second wall along the second direction. The second conductive path is disposed in the first recess extends along the second direction. The second conductive path is contiguous to the first wall. The second conductive path and the first conductive path are spaced apart from each other. The first switch is disposed in the first recess. The first switch is contiguous to and electrically connected to the first conductive path and the second conductive path. The first switch and the first control module are spaced apart from each other as viewed along the first direction. The first control member is disposed outside the first housing; the first control member is disposed opposite to the first wall along the second direction. The first control member is connected to the first switch and is configured to control closing and opening of the first switch. The control device is designed in a modular manner, so that all modules are compactly arranged to improve space efficiency.

In some embodiments of this application, when viewed along the first direction, the first control module overlaps the first conductive path.

In some embodiments of this application, along the first direction, the first control module and the first conductive path are spaced apart from each other.

In some embodiments of this application, the control device further includes a second control module. The second control module is disposed between the first control module and the first conductive path along the first direction.

In some embodiments of this application, the second control module is configured to perform a corresponding conversion on externally input electrical power.

In some embodiments of this application, the second control module is electrically connected to the first control module.

In some embodiments of this application, the first control module includes a first control submodule, a second control submodule, and a third control submodule. The first control submodule is configured to perform a corresponding control based on a status of an electrically connected battery. The second control submodule is configured to perform a corresponding control based on status of an electrically connected sensor. The third control submodule is configured to perform insulation monitoring by monitoring a resistance value of the first housing.

In some embodiments of this application, the first wall includes a first opening. The first opening communicates with the first recess. A gas in the first recess is exchangeable with a gas outside the first housing through the first opening.

In some embodiments of this application, the control device further includes a ventilation member. The ventilation member is disposed on the first wall and opposite to the first opening. The ventilation member is configured to accelerate exchange between the gas in the first recess and the gas outside the first housing.

In some embodiments of this application, the first switch is configured to have a first state and a second state. When the first switch is in the first state, the first control member overlaps the first opening as viewed along the second direction. When the first switch is in the second state, the first control member and the first opening are spaced apart from each other as viewed along the second direction.

In some embodiments of this application, in the first state: the first switch is electrically disconnected from the first conductive path and the second conductive path; and the second state: the first switch is electrically connected to the first conductive path and the second conductive path.

In some embodiments of this application, the control device further includes a first connecting member. The first connecting member is connected to the first control member and the first switch.

In some embodiments of this application, the first conductive path includes a first cut-off member and a second cut-off member. The first cut-off member is configured to cut off a connection path of the first conductive path when a current flowing through the first conductive path reaches a first threshold. The second cut-off member is configured to cut off the connection path of the first conductive path when the current flowing through the first conductive path reaches a second threshold.

In some embodiments of this application, the first conductive path satisfies at least one of the following conditions (a) or (b): (a) the first cut-off member includes a fuse, and the second cut-off member includes a fuse; or (b) the first conductive path is made of a material including copper.

In some embodiments of this application, the second conductive path includes a third cut-off member and a fourth cut-off member. The third cut-off member is configured to cut off a connection path of the second conductive path when a current flowing through the second conductive path reaches a third threshold. The fourth cut-off member is configured to cut off the connection path of the second conductive path when the current flowing through the second conductive path reaches a fourth threshold.

In some embodiments of this application, the second conductive path satisfies at least one of the following conditions (I) or (II): (I) the third cut-off member includes a fuse, and the fourth cut-off member includes a fuse; or (II) the second conductive path is made of a material including copper.

An embodiment of this application further provides a battery module. The battery module includes a second housing, a plurality of battery cells, and the control device disclosed in any one of the above embodiments. The plurality of battery cells are disposed in the second housing. The plurality of battery cells are connected to the control device. The plurality of battery cells and the control device are stacked along the first direction.

In some embodiments of this application, along a third direction perpendicular to the first direction and the second direction, a length of the control device is a first distance, and a length of the battery cell is a second distance. The first distance is equal to the second distance.

In some embodiments of this application, the battery module further includes a wire. The wire is electrically connected to the control device and at least one of the battery cells.

In some embodiments of this application, the battery cell includes an electrode assembly, a first terminal, and a second terminal. The first terminal and the second terminal are disposed on the same side of the electrode assembly and are electrically connected to the electrode assembly. Along the second direction, the first terminal and the second terminal are closer to the first wall than to the second wall.

In some embodiments of this application, along the first direction, the control device is disposed between two adjacent battery cells.

In some embodiments of this application, along the second direction, a length of the control device is a third distance, and a length of the battery cell is a fourth distance. The third distance is equal to the fourth distance.

In summary, the control device of this application is designed in a modular manner to improve space efficiency.

### BRIEF DESCRIPTION OF DRAWINGS

FIG. 1 is a first view of a control device according to an embodiment of this application;

FIG. 2 is an exploded view of FIG. 1;

FIG. 3 is a first view of an internal structure of a control device with a top wall removed according to an embodiment of this application;

FIG. 4 is a second view of an internal structure of a control device with a top wall removed according to an embodiment of this application;

FIG. 5 is a schematic structural diagram of an adapter unit according to an embodiment of this application;

FIG. 6 is a schematic structural diagram of a control device when a first switch is in a first state according to an embodiment of this application;

FIG. 7 is a schematic structural diagram of a control device when a first switch is in a second state according to an embodiment of this application;

FIG. 8 is a schematic structural diagram of a part of a control device with a panel removed when a first switch is in a second state according to an embodiment of this application;

FIG. 9 is a schematic structural diagram of a control device with a panel removed when a first switch is in a first state according to an embodiment of this application;

FIG. 10 is a schematic structural diagram of a control device when a first switch is in a first state according to an embodiment of this application;

FIG. 11 is a second view of a control device according to an embodiment of this application;

FIG. 12 is a cross-sectional view of sectioning along an A-A line shown in FIG. 11;

FIG. 13 is a schematic structural diagram of a first control submodule according to an embodiment of this application;

FIG. 14 is a schematic structural diagram of a second control submodule according to an embodiment of this application;

FIG. 15 is a schematic structural diagram of a third control submodule according to an embodiment of this application;

FIG. 16 is a schematic structural diagram of a fourth control submodule according to an embodiment of this application;

FIG. 17 is a schematic structural diagram of a second control module according to an embodiment of this application;

FIG. 18 is a first view of a battery module according to an embodiment of this application;

FIG. 19 is a second view of a battery module according to an embodiment of this application;

FIG. 20 is a third view of a control device according to an embodiment of this application; and

FIG. 21 is a schematic structural diagram of a battery cell according to an embodiment of this application.

### LIST OF REFERENCE NUMERALS

battery module 100
second housing 1
accommodation cavity unit 11
battery cell 2
battery housing 21
first terminal 22
second terminal 23
main positive connecting terminal 24
main negative connecting terminal 25
control device 3
first housing 31
first recess 310
first wall 311
first opening 3111
first plate 3112
first face 3113
second wall 312
third wall 313
fourth wall 314
bottom wall 315
top wall 316
clearance 317
first control module 321
first control submodule 3211
first base plate 32111
first side plate 32112
first chip module 32113
first power module 32114
first communicational connection unit 32116
first radio unit 32117
first display unit 32118
SOC indicator 32118a
warning light 32118b
first plug-in unit 32119
second control submodule 3212
second base plate 32121
second side plate 32122
second chip module 32123
second power module 32124
second communicational connection unit 32126
storage connection unit 32127
second plug-in unit 32128
third control submodule 3213
third base plate 32131
third side plate 32132
third chip module 32133
third power module 32134
voltage control unit 32135
third plug-in unit 32136
first filtering unit 32137
photoelectric coupling unit 32138
fourth control submodule 3214
fourth base plate 32141
fourth side plate 32142
fourth chip module 32143
fourth power module 32144
wireless communication module 32145
detection connection unit 32146
second control module 322
fifth base plate 3221
fifth side plate 3222
direct-current power module 3223
second filtering unit 3224
third communicational connection unit 3225
first conductive path 331
first part 331a
second part 331b
first cut-off member 3311a
second cut-off member 3311b
second conductive path 332
third part 332a
fourth part 332b
third cut-off member 3321a
fourth cut-off member 3321b
first control unit 3341
second control unit 3342
first switch 341
first control member 342
operation portion 3421
first connecting member 343
second connecting member 344
third connecting member 345
fourth connecting member 346
fifth connecting member 347
adapter unit 340
adapter base plate 3401
first adapter member 3402
second adapter member 3403
third adapter member 3404
panel 35
second opening 351
second plate 352
third plate 353
fourth plate 354
second side 355
third opening 361
fourth opening 362
fifth opening 363
sixth opening 364
second control member 348
third control member 349
first guide rail 371
second guide rail 372
third guide rail 373
fourth guide rail 374
fifth guide rail 375
ventilation member 38
temperature sensor 391
power conversion system 4
first wire 51
second wire 52
third wire 53
fourth wire 54
fifth wire 7
sixth wire 56
seventh wire 57
eighth wire 58
first direction Z
second direction Y
third direction X
fourth direction Y

This application is further described below with reference to some following specific embodiments and the foregoing drawings.

### DETAILED DESCRIPTION

The following describes the technical solutions in the embodiments of this application with reference to the drawings hereto. Evidently, the described embodiments are merely a part of but not all of the embodiments of this application.

It is hereby noted that a component considered to be “connected to” another component may be directly connected to the other component or may be connected to the other component through an intermediate component. A component considered to be “disposed on” another component may be directly disposed on the other component or may be disposed on the other component through an intermediate component.

Unless otherwise defined, all technical and scientific terms used herein bear the same meanings as what is normally understood by a person skilled in the technical field of this application. The terms used in the specification of this application are merely intended to describe some specific embodiments but not to limit this application. The term “and/or” used herein includes any and all combinations of one or more relevant items enumerated.

Unless otherwise defined, all technical and scientific terms used herein bear the same meanings as what is normally understood by a person skilled in the technical field of this application. The terms used in the specification of this application are merely intended to describe specific some embodiments but not to limit this application. As used herein, the term “perpendicular” or “vertical” is a description of an ideal state between two components. In the actual production or use state, one component may be approximately perpendicular to another component. For example, numerically, the term “perpendicular” may represent an angle of 90°+10° between two straight lines, or a dihedral angle of 90°+10° between two planes, or an angle of 90°=10° between a straight line and a plane. Two components described as “perpendicular” to each other may be not absolute straight lines or planes, but may be roughly straight lines or planes. An object is considered to be a “straight line” or “plane” if the overall extension direction of the object is a straight line or plane as viewed from a macro perspective.

An embodiment of this application provides a control device. The control device includes a first housing, a first control module, a first conductive path, a second conductive path, a first switch, and a first control member. The first housing includes a first recess. The first housing includes a first wall, a second wall, and a bottom wall. The first wall is disposed opposite to the second wall. The bottom wall is connected to the first wall and the second wall. The first wall, the second wall, and the bottom wall constitute some inner walls of the first recess. The first control module is disposed in the first recess. When viewed along a first direction perpendicular to the bottom wall, the distance between the first control module and the first wall is less than the distance between the first control module and the second wall. The first control module is configured to perform a corresponding control based on a status of an electrically connected battery. The first conductive path is disposed in the first recess extends along a second direction perpendicular to the first direction. The first conductive path is contiguous to the first wall. The first wall is opposite to the second wall along the second direction. The second conductive path is disposed in the first recess extends along the second direction. The second conductive path is contiguous to the first wall. The second conductive path and the first conductive path are spaced apart from each other. The first switch is disposed in the first recess. The first switch is contiguous to and electrically connected to the first conductive path and the second conductive path. The first switch and the first control module are spaced apart from each other as viewed along the first direction. The first control member is disposed outside the first housing. The first control member is disposed opposite to the first wall along the second direction. The first control member is connected to the first switch and is configured to control closing and opening of the first switch. The control device is designed in a modular manner, so that all modules are compactly arranged to improve space efficiency.

The following further describes some embodiments of this application with reference to drawings.

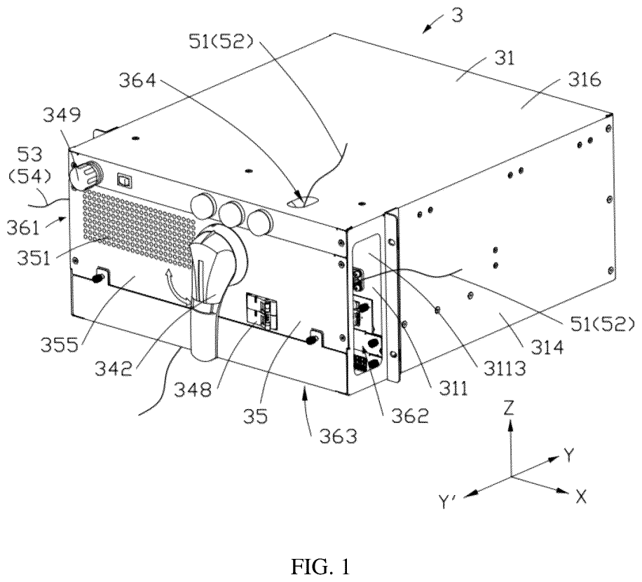

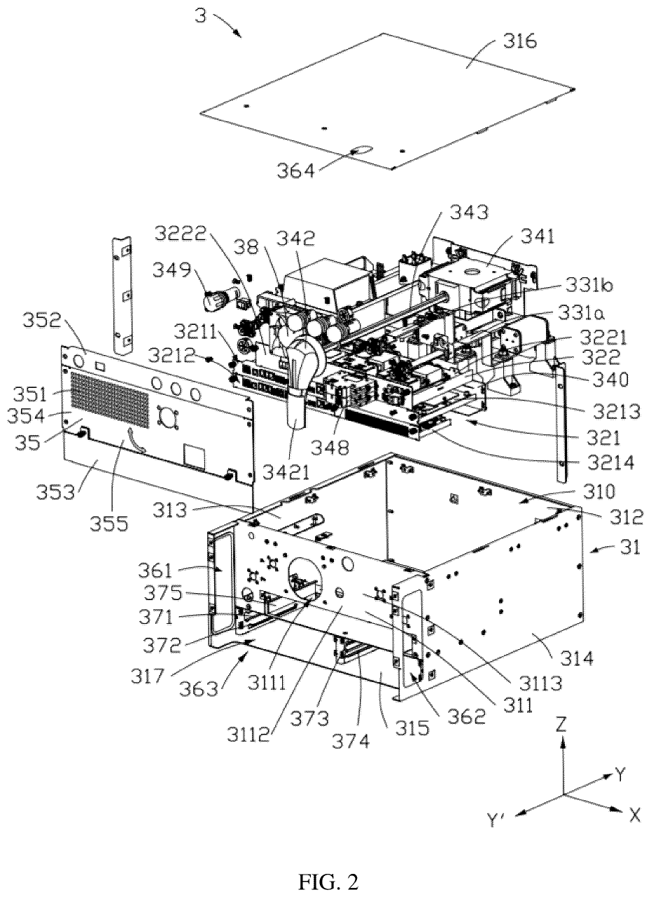

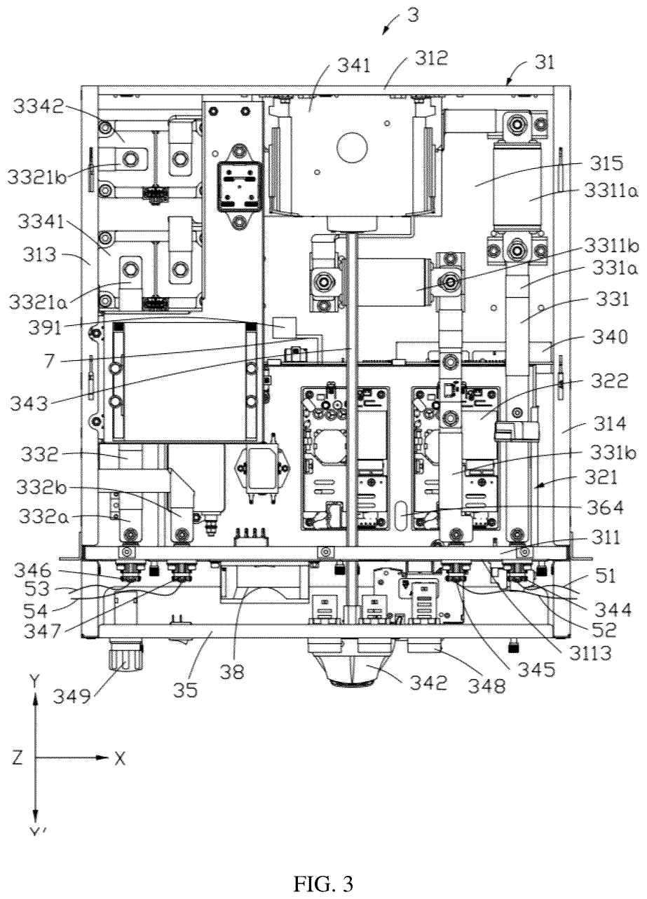

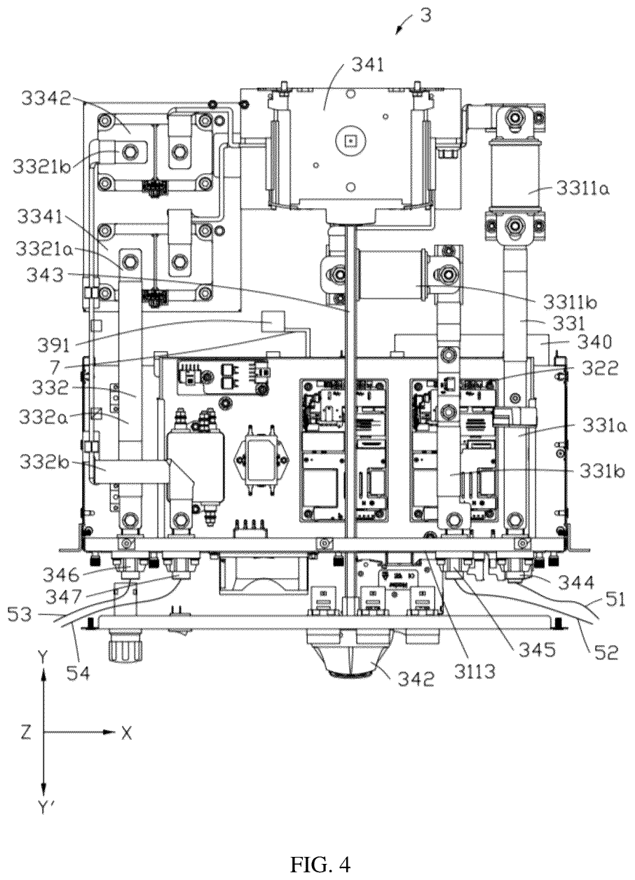

As shown in FIG. 1, FIG. 2, FIG. 3, and FIG. 4, an embodiment of this application provides a control device 3. The control device 3 is configured to be electrically connected to a battery cell, and can control the charging and discharging of the battery cell. The control device 3 includes a first housing 31, a first control module 321, a first conductive path 331, a second conductive path 332, a first switch 341, and a first control member 342.

The first housing 31 includes a first recess 310. The first control module 321, the first conductive path 331, the second conductive path 332, and the first switch 341 are disposed in the first recess 310.

The first housing 31 includes a first wall 311, a second wall 312, a third wall 313, a fourth wall 314, a bottom wall 315, and a top wall 316. The first wall 311 and the second wall 312 are disposed opposite to each other along the second direction Y. The third wall 313 and the fourth wall 314 are disposed opposite to each other along the third direction X perpendicular to the second direction Y. Both the third wall 313 and the fourth wall 314 are connected to the first wall 311 and the second wall 312. The top wall 316 and the bottom wall 315 are disposed opposite to each other along the first direction Z perpendicular to the second direction Y and the third direction X. Both the top wall 316 and the bottom wall 315 are connected to the first wall 311, the second wall 312, the third wall 313, and the fourth wall 314. The first wall 311, the second wall 312, the third wall 313, the fourth wall 314, and the bottom wall 315 close in to form a first recess 310. The first direction Z is perpendicular to the bottom wall 315. In an embodiment, the first wall 311 includes a first face 3113. The first face 3113 is located on a side, the side being oriented away from the first recess 310.

The positional terms “top” and “bottom” used herein are merely used to assist in the description, so as to facilitate the understanding of this application with reference to the drawings, but are not intended to limit this application. As an example, the following gives a more detailed description by using an example in which the bottom wall 315 is located at the bottom and the top wall 316 is located on the top.

The first control module 321 is electrically connected to a battery unit and other modules in the first housing 31, and can control the charging and discharging of the battery cell based on the status of the battery cell, and control the charging and discharging of the battery cell based on the information from other modules. The first control module 321 can also acquire voltage and current information in the control device 3, and monitor whether a short circuit problem occurs in the control device 3.

When viewed along the first direction Z, the first control module 321 is located between the first wall 311 and the second wall 312. The first control module 321 is closer to the first wall 311 than to the second wall 312. When viewed along the second direction Y, the first control module 321 is located between the bottom wall 315 and the top wall 316. The first control module 321 is closer to the bottom wall 315 than to the top wall 316. Along the second direction Y, the first control module 321 is closer to the first wall 311 than to the second wall 312. The first control module 321 being positioned close to the first wall 311 facilitates wiring, so that the wires are connected to the first control module 321 through the first wall 311, thereby improving the space efficiency.

In an embodiment, the first control module 321 includes a first control submodule 3211, a second control submodule 3212, and a third control submodule 3213. The first control submodule 3211, the second control submodule 3212, and the third control submodule 3213 are electrically connected to each other.

The first control submodule 3211 is electrically connected to the battery cell, so that the first control submodule 3211 can perform a corresponding control based on the status of the battery cell. For example, the first control submodule 3211 can control the charging and discharging of the battery cell 2 based on the voltage and temperature information of the battery cell. In an embodiment, the first control submodule 3211 includes a battery control unit (BCU for short) module. The BCU module may be configured to acquire the voltage and temperature information of the battery cell.

The second control submodule 3212 is electrically connected to the sensor of the battery cell. The second control submodule 3212 can perform a corresponding control on the battery cell based on the information from the sensor. Optionally, the second control submodule 3212 is electrically connected to the BCU module. In an embodiment, the second control submodule 3212 includes a battery array management system (BAMS for short) module. In an embodiment, the second control submodule 3212 is electrically connected to and communicates with an external power conversion system (PCS for short) module. In an embodiment, the second control submodule 3212 is electrically connected to and communicates with an external energy management system (EMS for short) module.

The third control submodule 3213 can acquire voltage and current information in the control device 3 and perform insulation monitoring to monitor whether a short circuit problem occurs in the control device 3, thereby improving the safety performance of the control device 3. In this application, the insulation monitoring performed by the third control submodule 3213 enables the control device 3 to monitor the resistance between the positive connecting member or the negative connecting member and the first housing 31, where the positive connecting member and the negative connecting member are connected to the battery cell. If the resistance value is obviously abnormal, a short-circuit fault may occur. In an embodiment, the third control submodule 3213 includes an IVU module.

In an embodiment, the first control module 321 further includes a fourth control submodule 3214. The first control submodule 3211, the second control submodule 3212, the third control submodule 3213, and the fourth control submodule 3214 are electrically connected to each other. The fourth control submodule 3214 can acquire monitoring data of the environment in which the control device 3 is located. For example, the monitoring data is information such as temperature, smoke, access control, and water control of the environment in which the control device 3 is located. In an embodiment, the fourth control submodule 3214 includes an environment sensing unit (ESU for short) module. The ESU module is configured to monitor the temperature and humidity of the environment in which the fourth control submodule 3214 is located.

In an embodiment, the control device 3 further includes a second control module 322. The second control module 322 is disposed in the first recess 310. Along the first direction Z, the second control module 322 is disposed between the first control module 321 and the first conductive path 331, thereby improving the space efficiency in the first housing 31. In an embodiment, the second control module 322 is electrically connected to the first control module 321. In an embodiment, the second control module 322 is electrically connected to an external power supply. The second control module 322 may be configured to perform a corresponding conversion on the electrical power input by the external power supply. For example, the second control module 322 is configured to regulate the voltage or current input by the external power supply.

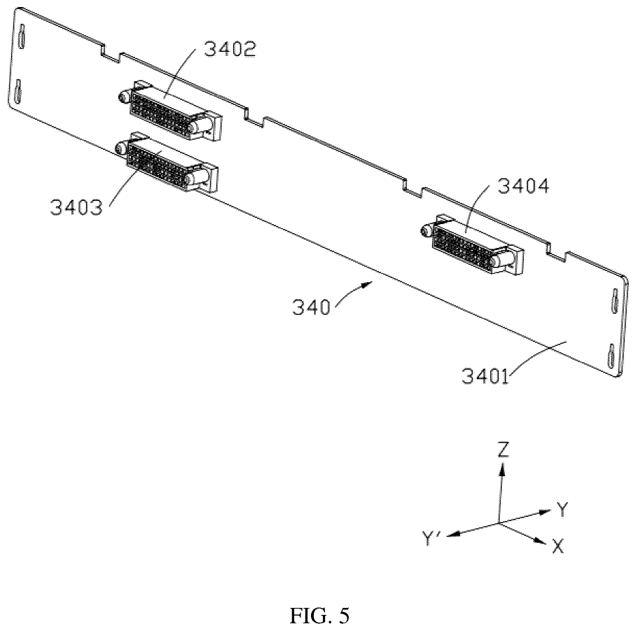

Referring to FIG. 2, FIG. 4, and FIG. 5, in an embodiment, the control device 3 further includes an adapter unit 340. The adapter unit 340 is disposed in the first recess 310, and is configured to connect the first control module 321 and the second control module 322. Specifically, the adapter unit 340 is electrically connected to the first control module 321, the first control submodule 3211, the second control submodule 3212, the third control submodule 3213, and the fourth control submodule 3214. In this way, the first control submodule 3211, the second control submodule 3212, the third control submodule 3213, and the fourth control submodule 3214 are electrically connected to each other, and are all electrically connected to the first control module 321.

In an embodiment, the first control module 321, the first control submodule 3211, the second control submodule 3212, and the third control submodule 3213 are connected to the adapter unit 340 in a plug-in manner. In an embodiment, the adapter unit 340 includes an adapter base plate 3401, a first adapter member 3402, a second adapter member 3403, and a third adapter member 3404. The first adapter member 3402, the second adapter member 3403, and the third adapter member 3404 are disposed on the adapter base plate 3401. The first adapter member 3402, the second adapter member 3403, and the third adapter member 3404 protrude beyond the adapter base plate 3401 along a fourth direction Y′ opposite to the second direction Y. The first adapter member 3402 is configured to be connected to the first control submodule 3211. The second adapter member 3403 is configured to be connected to the second control submodule 3212. The third adapter member 3404 is configured to be connected to the third control submodule 3213.

In an embodiment, the fourth control submodule 3214 is connected to the adapter unit 340 by a connector (not shown in the drawing).

Still referring to FIG. 1, FIG. 2, FIG. 3, and FIG. 4, when viewed along the first direction Z, the first switch 341 and the first control module 321 are spaced apart from each other. Along the second direction Y, a part of the first conductive path 331 is disposed between the first switch 341 and the first control module 321. The first switch 341 is closer to the second wall 312 than to the first wall 311. The first switch 341 is close to the second wall 312, and the first control module 321 is close to the first wall 311, thereby reducing signal transmission interference between the first switch 341 and the first control module 321, and improving the rationality of the module layout and space efficiency in the first housing 31.

The first control member 342 is disposed outside the first housing 31. The first control member 342 is disposed opposite to the first wall 311 along the second direction Y. The first control member 342 is connected to the first switch 341. The first control member 342 is configured to control closing and opening of the first switch 341.

In an embodiment, the control device 3 further includes a first connecting member 343. The first connecting member 343 is connected to the first control member 342 and the first switch 341. The first control member 342 can control the closing and opening of the first switch 341 through the first connecting member 343.

In an embodiment, the first control member 342 includes an operation portion 3421. The operation portion 3421 is located on a side of the panel 35, the side being oriented away from the first housing 31. The operation portion 3421 is rotatably connected to the panel 35. By rotating the operation portion 3421, the first control member 342 can control the closing and opening of the first switch 341.

In an embodiment, the operation portion 3421 is connected to the first connecting member 343. The operation portion 3421 can drive the first connecting member 343 to rotate to switch over the first switch 341 between a closed state and an opened state.

In an embodiment, the control device 3 further includes a panel 35. The panel 35 is disposed outside the first housing 31. The panel 35 is detachably connected to the first housing 31. The panel 35 and the first wall 311 are disposed opposite to each other along the second direction Y. In an embodiment, along the fourth direction Y′, the third wall 313 and the fourth wall 314 extend and protrude beyond the first wall 311. The protruding portions of the third wall 313 and the fourth wall 314 extending and protruding beyond the first wall 311 are connected to the panel 35. A gap exists between the panel 35 and the first wall 311. In an embodiment, the panel 35 includes a second face 355. The second face 355 is located on a side oriented away from the first wall 311.

The first control member 342 is disposed on the panel 35. Along the fourth direction Y′, at least a part of the first control member 342 extends out of the second face 355.

In an embodiment, the first conductive path 331 extends along the second direction Y. The first conductive path 331 is contiguous to the first wall 311. The first conductive path 331 is contiguous to and electrically connected to the first switch 341. In an embodiment, when viewed along the first direction Z, the first control module 321 overlaps the first conductive path 331. The arrangement by which first control module 321 overlaps the first conductive path 331 along the first direction Z can improve the space efficiency in the first housing 31. In an embodiment, along the first direction Z, the first control module 321 and the first conductive path 331 are spaced apart from each other, thereby reducing the mutual interference between the first control module 321 and the first conductive path 331. The first conductive path 331 includes a first part 331a and a second part 331b. Both the first part 331a and the second part 331b are contiguous to the first wall 311. Both the first part 331a and the second part 331b are contiguous to and electrically connected to the first switch 341. When viewed along the first direction Z, the first part 331a and the second part 331b are spaced apart from each other along the third direction X.

The second conductive path 332 extends along the second direction Y. The second conductive path 332 is contiguous to the first wall 311. The second conductive path 332 is contiguous to and electrically connected to the first switch 341. The second conductive path 332 includes a third part 332a and a fourth part 332b. Both the third part 332a and the fourth part 332b are contiguous to the first wall 311. Both the third part 332a and the fourth part 332b are contiguous to and electrically connected to the first switch 341. When viewed along the first direction Z, the third part 332a overlaps the fourth part 332b. One end of the third part 332a and one end of the fourth part 332b are space from each other along the third direction X, one end of the third part 332a being an end connect to the first wall 311, one end of the fourth part 332b being an end connect to the first wall 311.

The second conductive path 332 and the first conductive path 331 are spaced apart from each other, thereby reducing the mutual interference between the second conductive path 332 and the first conductive path 331.

In an embodiment, the first switch 341 is electrically connected to the first conductive path 331. In an embodiment, the first switch 341 is electrically connected to the second conductive path 332.

In an embodiment, the first conductive path 331 includes a first cut-off member 3311a and a second cut-off member 3311b. The first cut-off member 3311a is configured to cut off the connection path of the first part 331a when the current flowing through the first part 331a reaches a first threshold. The second cut-off member 3311b is configured to cut off the connection path of the second part 331b when the current flowing through the second part 331b reaches a second threshold, thereby improving the safety performance of the control device 3. In an embodiment, the first cut-off member 3311a is connected to the first part 331a. The second cut-off member 3311b is connected to the second part 331b.

In an embodiment, the first cut-off member 3311a includes a fuse. In an embodiment, the length of the first cut-off member 3311a is less than the length of the first conductive path 331.

In an embodiment, the second cut-off member 3311b includes a fuse. In an embodiment, the length of the second cut-off member 3311b is less than the length of the first conductive path 331.

In an embodiment, the first conductive path 331 is made of a material including copper.

In an embodiment, the second conductive path 332 includes a third cut-off member 3321a and a fourth cut-off member 3321b. The third cut-off member 3321a is configured to cut off the connection path of the third part 332a when the current flowing through the third part 332a reaches a third threshold. The fourth cut-off member 3321b is configured to cut off the connection path of the fourth part 332b when the current flowing through the fourth part 332b reaches a fourth threshold, thereby improving the safety performance of the control device 3. In an embodiment, the third cut-off member 3321a is connected to the third part 332a. The fourth cut-off member 3321b is connected to the fourth part 332b.

In an embodiment, the third cut-off member 3321a includes a fuse. In an embodiment, the length of the third cut-off member 3321a is less than the length of the second conductive path 332.

In an embodiment, the fourth cut-off member 3321b includes a fuse. In an embodiment, the length of the fourth cut-off member 3321b is less than the length of the second conductive path 332.

In an embodiment, the second conductive path 332 is made of a material including copper.

In an embodiment, the control device 3 further includes a first control unit 3341. The first control unit 3341 is disposed in the first housing 31, and is connected to the third part 332a. The first control unit 3341 can control the opening and closing of the third part 332a. Optionally, the first control unit 3341 includes a relay.

In an embodiment, the control device 3 further includes a second control unit 3342. The second control unit 3342 is disposed in the first housing 31, and is connected to the fourth part 332b. The second control unit 3342 can control the opening and closing of the fourth part 332b. Optionally, the second control unit 3342 includes a relay.

In an embodiment, the control device 3 further includes a second connecting member 344 and a third connecting member 345. The second connecting member 344 and the third connecting member 345 are disposed on the first wall 311. The second connecting member 344 and the third connecting member 345 extend out of the first face 3113 along the fourth direction Y′. The first part 331a is contiguous to and electrically connected to the second connecting member 344. The second part 331b is contiguous to and electrically connected to the third connecting member 345. The second connecting member 344 and the third connecting member 345 are configured to be electrically connected to the battery cell, so that the control device 3 and the battery cell can form a closed loop to control the battery cell.

In an embodiment, the wire includes a first wire 51. The second connecting member 344 is electrically connected to the battery cell by the first wire 51. In an embodiment, the wire includes a second wire 52. The third connecting member 345 is electrically connected to the battery cell by the second wire 52.

In an embodiment, the control device 3 further includes a fourth connecting member 346 and a fifth connecting member 347. The fourth connecting member 346 and the fifth connecting member 347 are disposed on the first wall 311. The fourth connecting member 346 and the fifth connecting member 347 extend out of the first face 3113 along the fourth direction Y′. The third part 332a is contiguous to and electrically connected to the fourth connecting member 346. The fourth part 332b is contiguous to and electrically connected to the fifth connecting member 347. The fourth connecting member 346 and the fifth connecting member 347 are configured to be connected to an external power conversion system (PCS for short). In this way, the power conversion system can combine with the control device 3 to form a closed loop, so that the control device 3 controls the charging and discharging of the battery cell, thereby implementing protective charging and discharging of the battery cell and ensuring safe operation of the battery cell.

In an embodiment, the wire includes a third wire 53. The fourth connecting member 346 is electrically connected to the power conversion system (not shown in the drawing) outside the control device 3 through the third wire 53. In an embodiment, the wire includes a fourth wire 54. The fifth connecting member 347 is electrically connected to the power conversion system outside the control device 3 through the fourth wire 54.

In an embodiment, the first wall 311 includes a first opening 3111. The first opening 3111 communicates with the first recess 310. The gas in the first recess 310 is exchangeable with the gas outside the first housing 31 through the first opening 3111.

In an embodiment, the control device 3 further includes a ventilation member 38. The ventilation member 38 is disposed on the first wall 311 and opposite to the first opening 3111 along the second direction Y. The ventilation member 38 is configured to accelerate exchange between the gas in the first recess 310 and the gas outside the first housing 31, thereby increasing the heat dissipation speed of the control device 3. In an embodiment, the ventilation member 38 includes, but is not limited to, any one of a fan or an air conditioner.

In an embodiment, the control device 3 further includes a temperature sensor 391. The temperature sensor 391 is disposed in the first recess 310, and can monitor the temperature of each module in the control device 3. In an embodiment, along the second direction Y, the temperature sensor 391 is disposed between the first switch 341 and the first control module 321, thereby improving the space efficiency in the first housing 31. In an embodiment, the temperature sensor 391 is closer to the first control module 321 and the second control module 322 than to the first switch 341. In this way, the temperature sensor 391 can monitor the temperature of the first control module 321 and the second control module 322 conveniently. The second control submodule 3212 is electrically connected to the temperature sensor 391 and the ventilation member 38. Based on the temperature information monitored by the temperature sensor 391, the second control submodule 3212 can control the ventilation member 38 to work and stop working, so that the temperature of each module in the control device 3 falls within a safe range, thereby reducing the risk of abnormality of the control device 3 caused by high temperature. In an embodiment, the second control submodule 3212 is electrically connected to the temperature sensor 391 by the fifth wire 7.

In an embodiment, the panel 35 includes a second opening 351. The second opening 351 communicates with the first recess 310. Optionally, along the second direction Y, the second opening 351 is disposed opposite to the first opening 3111. The projection of the second opening 351 overlaps the projection of the first opening 3111, thereby increasing the speed of gas circulation through the first opening 3111 and the second opening 351, and increasing the heat dissipation speed of the control device 3.

Optionally, a plurality of second openings 351 are disposed. The plurality of second openings 351 are arranged in arrays along the first direction Z and the third direction X. In an embodiment, the aperture of the first opening 3111 is D1, and the aperture of the second opening 351 is D2, satisfying: D1>D2. Optionally, 0.5 mm≤D2≤3 mm, thereby reducing the risk that foreign debris enters the first housing 31 through the second opening 351.

In an embodiment, the control device 3 further includes a third opening 361, a fourth opening 362, and a fifth opening 363. The third opening 361, the fourth opening 362, and the fifth opening 363 are located between the first wall 311 and the panel 35, and all communicate to the space between the first wall 311 and the panel 35. The third opening 361 and the fourth opening 362 are disposed opposite to each other along the third direction X. The third opening 361 is located at one end of the panel 35 along the third direction X. The fourth opening 362 is located at another end of the panel 35 along the third direction X. The fifth opening 363 is located at the lower end of the panel 35 along the first direction Z. The third opening 361, the fourth opening 362, and the fifth opening 363 allow wires to pass through, thereby facilitating wiring and gas circulation and accelerating heat dissipation. Optionally, the third opening 361 allows the third wire 53 and the fourth wire 54 to pass through. Optionally, the fourth opening 362 allows the first wire 51 and the second wire 52 to pass through. Optionally, the fifth opening 363 allows at least one of the first wire 51, the second wire 52, the third wire 53, or the fourth wire 54 to pass through.

In an embodiment, the control device 3 further includes a sixth opening 364. The sixth opening 364 is disposed on the top wall 316. The sixth opening 364 communicates to the space between the first wall 311 and the panel 35. The sixth opening 364 allows wires to connect the top of the control device 3 to the first wall 311 or the panel 35, thereby facilitating wiring. Optionally, the sixth opening 364 allows the first wire 51 and the second wire 52 to pass through.

In an embodiment, the control device 3 further includes a second control member 348. The second control member 348 is disposed on the second control module 322. The panel 35 includes a second face 355 away from the second wall 312. The second control member 348 partially extends out of the second face 355 along the fourth direction Y′. The second control member 348 is electrically connected to the first switch 341, and can control the closing and opening of the first switch 341 based on the information on the voltage and current in the control device 3. For example, when a short circuit or overload occurs in the control device 3, the second control member 348 can cut off the closed path from the first switch 341 to the first conductive path 331 and the second conductive path 332.

In an embodiment, the control device 3 further includes a third control member 349. The third control member 349 is disposed on the panel 35, and partially extends out of the second face 355 along the fourth direction Y′. The third control member 349 is electrically connected to the first switch 341, and is configured to cut off the closed path from the first switch 341 to the first conductive path 331 and the second conductive path 332. Optionally, the third control member 349 includes an emergency stop button. The emergency stop button can be pressed to immediately cut off the closed path from the first switch 341 to the first conductive path 331 and the second conductive path 332.

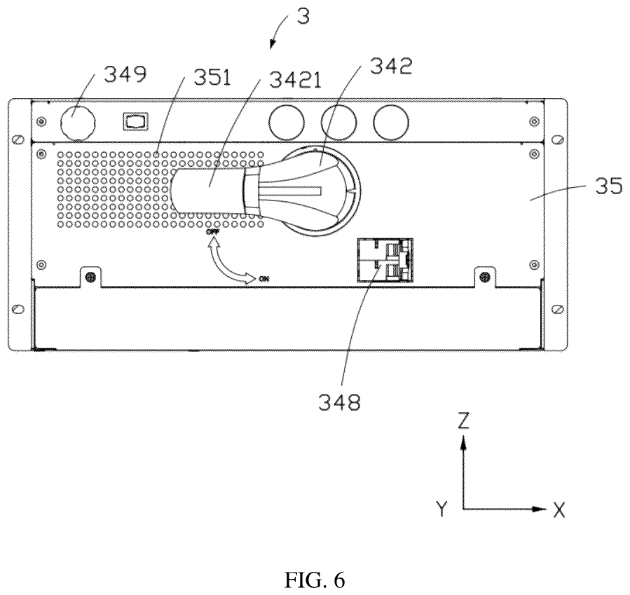

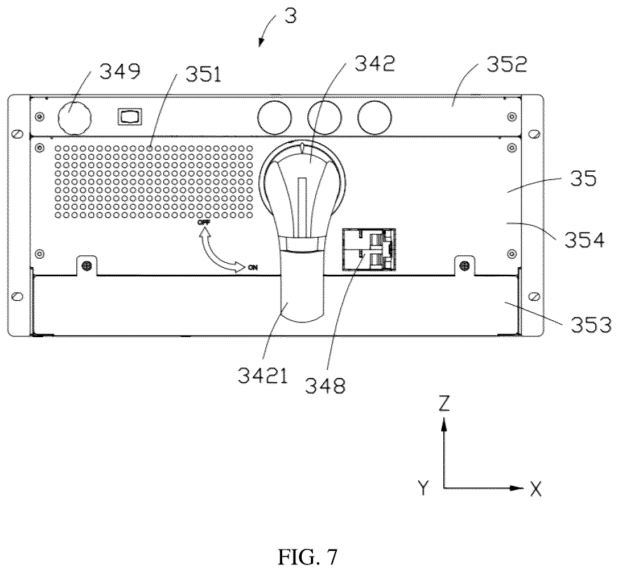

Referring to FIG. 3, FIG. 4, FIG. 6, and FIG. 7, in an embodiment, the first switch 341 is configured to have a first state and a second state. In an embodiment, when the first switch 341 is in the first state, the first part 331a and the second part 331b are in an open state, and the third part 332a and the fourth part 332b are in an open state. When the first switch 341 is in the second state, the first part 331a and the second part 331b are in a closed state, and the third part 332a and the fourth part 332b are in a closed state.

As shown in FIG. 6, when the first switch 341 is in the first state, the operation portion 3421 overlaps the second opening 351 as viewed along the second direction Y. Optionally, when the first switch 341 is in the first state, the length direction of the operation portion 3421 is parallel to the third direction X.

As shown in FIG. 7, when the first switch 341 is in the second state, the operation portion 3421 and the second opening 351 are spaced apart from each other, and the operation portion 3421 and the first opening 3111 are spaced apart from each other, as viewed along the second direction Y. Optionally, when the first switch 341 is in the second state, the length direction of the operation portion 3421 is parallel to the first direction Z, and the length direction of the operation portion 3421 is perpendicular to the third direction X.

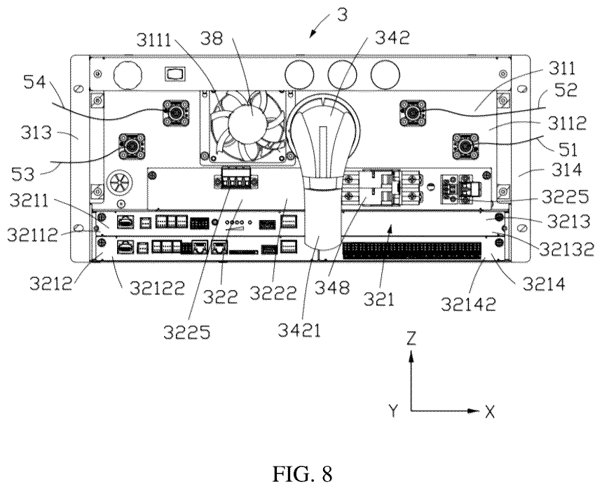

As shown in FIG. 8, when the first switch 341 is in the second state, the operation portion 3421 and the first opening 3111 are spaced apart from each other, and the operation portion 3421 overlaps the first control module 321, as viewed along the second direction Y, thereby constraining the detachment of the first control module 321.

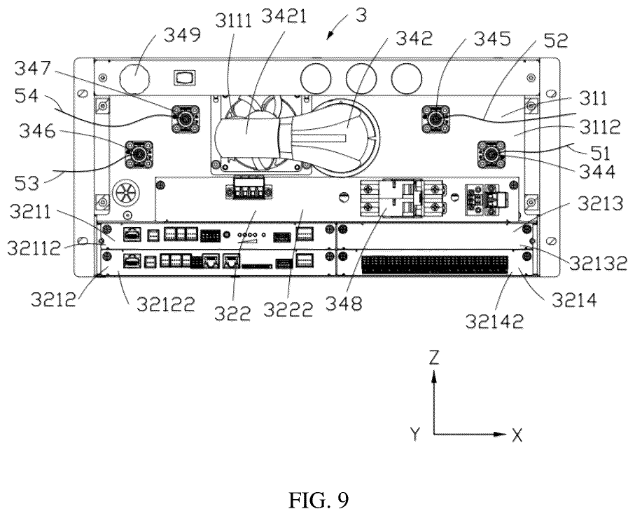

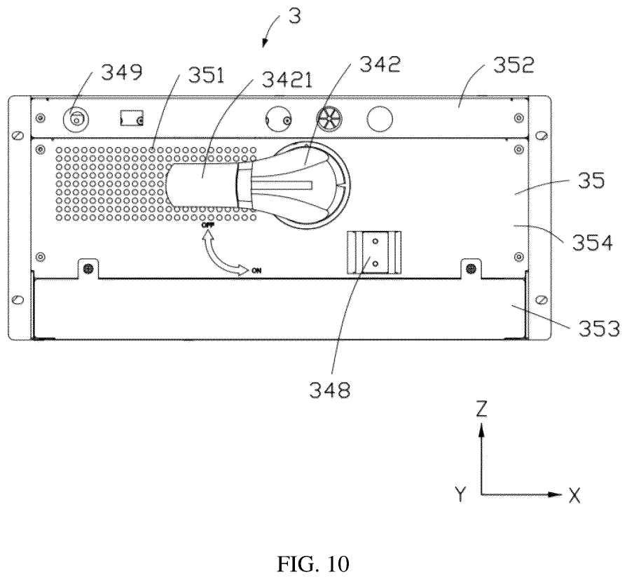

Referring to FIG. 2, FIG. 8, FIG. 9, and FIG. 10, the first wall 311 includes a first plate 3112. The first plate 3112 connects the third wall 313 and the fourth wall 314. A clearance 317 exists between the first plate 3112 and the bottom wall 315. The first control submodule 3211, the second control submodule 3212, the third control submodule 3213, and the fourth control submodule 3214 are disposed in the clearance 317 between the first plate 3112 and the bottom wall 315.

Optionally, the first control submodule 3211 and the second control submodule 3212 are disposed opposite to each other along the first direction Z. The third control submodule 3213 and the fourth control submodule 3214 are disposed opposite to each other along the first direction Z. The first control submodule 3211 and the third control submodule 3213 are disposed opposite to each other along the third direction X. The second control submodule 3212 and the fourth control submodule 3214 are disposed opposite to each other along the third direction X. Along the first direction Z, the first control submodule 3211 is located between the first plate 3112 and the second control submodule 3212. The third control submodule 3213 is located between the first plate 3112 and the fourth control submodule 3214.

In an embodiment, the first control submodule 3211 includes a first side plate 32112. The first side plate 32112 is detachably connected to the first housing 31. In an embodiment, the first side plate 32112 is connected to the first housing 31. The first control submodule 3211 is connected to the adapter unit 340. In an embodiment, after the first side plate 32112 is disconnected from the first housing 31, the first control submodule 3211 can be pulled out of the first recess 310 by pulling the first side plate 32112, so that the first control submodule 3211 is detached from the adapter unit 340.

In an embodiment, the first side plate 32112 is detachably connected to the first housing 31 by a screw.

In an embodiment, the second control submodule 3212 includes a second side plate 32122. The second side plate 32122 is detachably connected to the first housing 31. In an embodiment, the second side plate 32122 is connected to the first housing 31. The second control submodule 3212 is connected to the adapter unit 340. In an embodiment, after the second side plate 32122 is disconnected from the first housing 31, the second control submodule 3212 can be pulled out of the first recess 310 by pulling the second side plate 32122, so that the second control submodule 3212 is detached from the adapter unit 340.

In an embodiment, the second side plate 32122 is detachably connected to the first housing 31 by a screw.

In an embodiment, the third control submodule 3213 includes a third side plate 32132. The third side plate 32132 is detachably connected to the first housing 31. In an embodiment, the third side plate 32132 is connected to the first housing 31. The third control submodule 3213 is connected to the adapter unit 340. In an embodiment, after the third side plate 32132 is disconnected from the first housing 31, the third control submodule 3213 can be pulled out of the first recess 310 by pulling the third side plate 32132, so that the third control submodule 3213 is detached from the adapter unit 340.

In an embodiment, the third side plate 32132 is detachably connected to the first housing 31 by a screw.

In an embodiment, the fourth control submodule 3214 includes a fourth side plate 32142. The fourth side plate 32142 is detachably connected to the first housing 31. In an embodiment, the fourth side plate 32142 is connected to the first housing 31. The fourth control submodule 3214 is connected to the adapter unit 340. In an embodiment, after the fourth side plate 32142 is disconnected from the first housing 31, the fourth control submodule 3214 can be pulled out of the first recess 310 by pulling the fourth side plate 32142, so that the fourth control submodule 3214 is detached from the adapter unit 340.

In an embodiment, the fourth side plate 32142 is detachably connected to the first housing 31 by a screw.

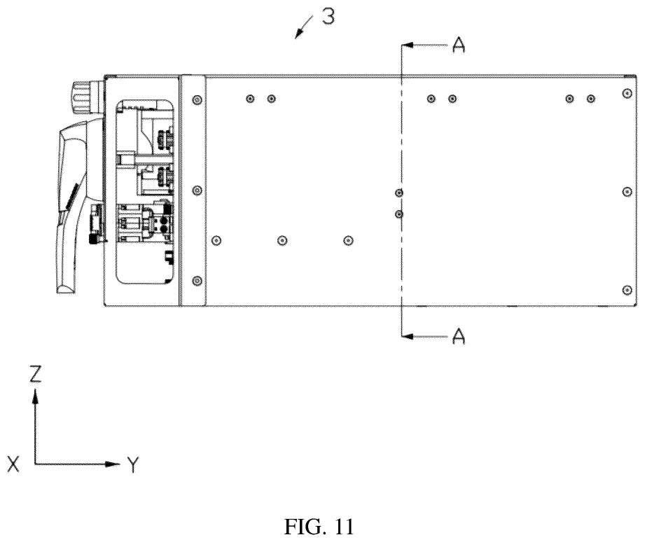

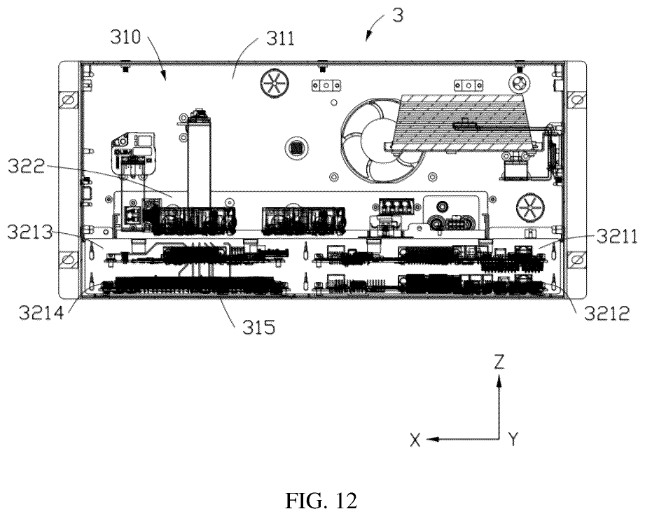

As shown in FIG. 11 and FIG. 12, in an embodiment, the second control module 322 is located on one side of the first control submodule 3211 and the third control submodule 3213, the side being oriented away from the bottom wall 315. The first control submodule 3211, the second control submodule 3212, the third control submodule 3213, and the fourth control submodule 3214 are disposed adjacent to the second control module 322, thereby making it convenient to dispose the adapter unit 340, getting connected to the adapter unit 340 concurrently, and improving the space efficiency.

Referring to FIG. 2, FIG. 7, and FIG. 8, in an embodiment, the second control module 322 includes a fifth side plate 3222. The fifth side plate 3222 is detachably connected to the first housing 31. In an embodiment, the fifth side plate 3222 is connected to the first housing 31. The second control module 322 is connected to the adapter unit 340. In an embodiment, after the fifth side plate 3222 is disconnected from the first housing 31, the second control module 322 can be pulled out of the first recess 310 by pulling the fifth side plate 3222, so that the second control module 322 is detached from the adapter unit 340.

In an embodiment, the fifth side plate 3222 is detachably connected to the first housing 31 by a screw.

In an embodiment, the panel 35 includes a second plate 352 and a third plate 353. The third plate 353 is detachably connected to the second plate 352. In an embodiment, the third plate 353 is detachably connected to the second plate 352 by a screw.

In an embodiment, along the second direction Y, the projections of the first side plate 32112, the second side plate 32122, the third side plate 32132, and the fourth side plate 32142 overlap the projection of the third plate 353. Optionally, the projections of the first side plate 32112, the second side plate 32122, the third side plate 32132, and the fourth side plate 32142 fall within the projection of the third plate 353. After the third plate 353 is detached, the first side plate 32112, the second side plate 32122, the third side plate 32132, and the fourth side plate 32142 can be operated.

In an embodiment, the panel 35 further includes a fourth plate 354. The fourth plate 354 is disposed between the second plate 352 and the third plate 353, and connects the second plate 352 and the third plate 353. The fourth plate 354 is detachably connected to the second plate 352. The third plate 353 is detachably connected to the fourth plate 354.

In an embodiment, along the second direction Y, the projection of the fifth side plate 3222 overlaps the projection of the fourth plate 354. Optionally, the projection of the fifth side plate 3222 falls within the projection of the fourth plate 354. After the fourth plate 354 is detached, the fifth side plate 3222 can be operated.

In an embodiment, the first control member 342 is disposed on the fourth plate 354.

When the first switch 341 is in the second state, the electrical connections from the first switch 341 to the first conductive path 331 and the second conductive path 332 are in a closed state. The operation portion 3421 overlaps the third plate 353 when viewed along the second direction Y. Optionally, when the first switch 341 is in the second state, the operator is restricted from detaching the third plate 353 from the fourth plate 354, and the operator is restricted from operating the first side plate 32112, the second side plate 32122, the third side plate 32132, and the fourth side plate 32142 without power-off, thereby reducing the impact on the operator.

Referring to FIG. 2, FIG. 9, and FIG. 10, when the first switch 341 is in the first state, the electrical connections from the first switch 341 to the first conductive path 331 and the second conductive path 332 are in a cut-off state. When viewed along the second direction Y, the operation portion 3421 and the third plate 353 are spaced apart from each other. In this case, after the third plate 353 is detached from the fourth plate 354, the first side plate 32112, the second side plate 32122, the third side plate 32132, and the fourth side plate 32142 can be operated, thereby improving safety. Optionally, when the first switch 341 is in the first state, the panel 35 can be detached from the first housing 31, so as to enable operation on the first wall 311 and the wires connected to the first wall 311, and in turn, improve safety.

Optionally, the second opening 351 is disposed on the fourth plate 354.

Optionally, the second control member 348 extends out of the fourth plate 354.

Optionally, the third control member 349 extends out of the second plate 352.

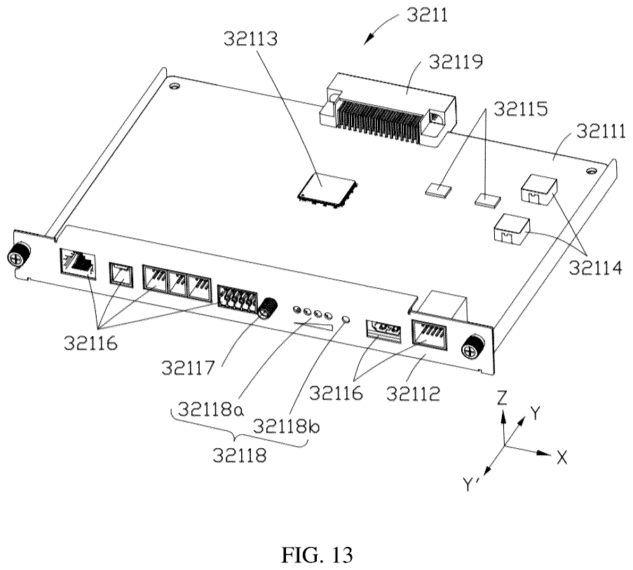

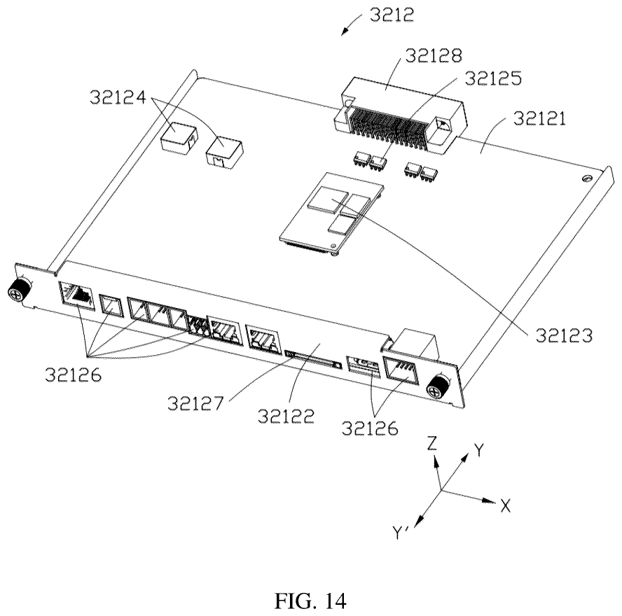

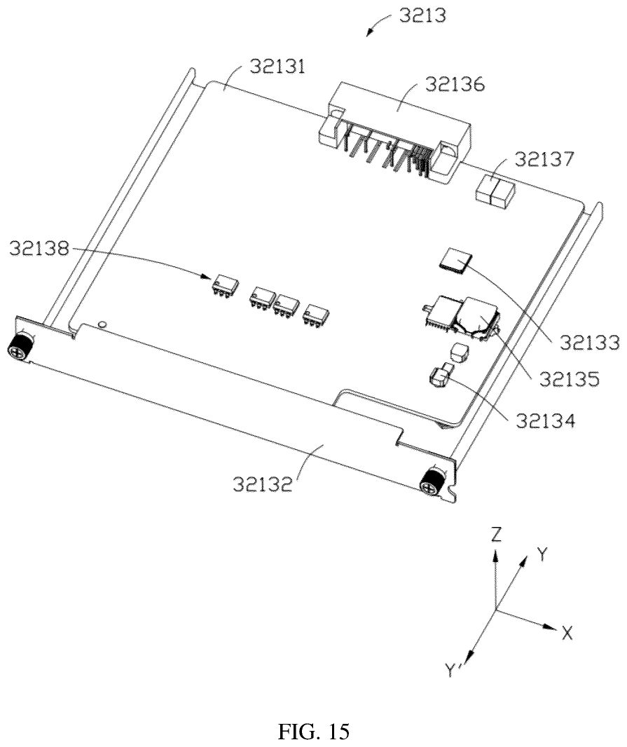

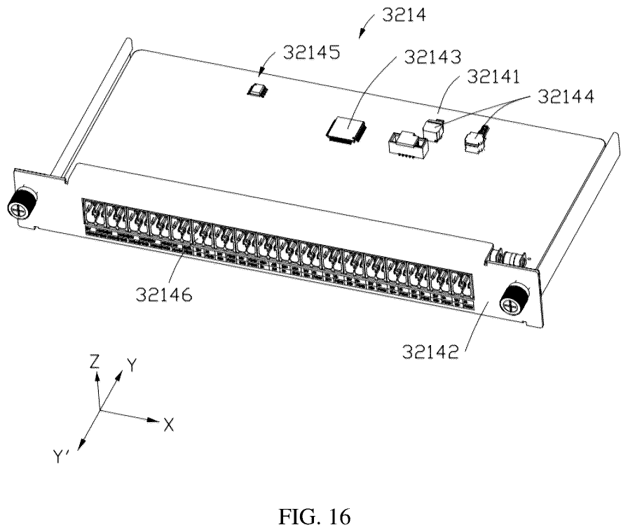

Referring to FIG. 2, FIG. 13, FIG. 14, FIG. 15, and FIG. 16, in an embodiment, the first control submodule 3211 further includes a first base plate 32111. The first base plate 32111 is connected to the first side plate 32112. The first base plate 32111 can slide relative to the first housing 31 along the second direction Y. In this way, the first side plate 32112 can drive the first control submodule 3211 to move out of the first housing 31, so as to facilitate maintenance for the first control submodule 3211.

In an embodiment, the first control submodule 3211 includes a first chip module 32113. The first chip module 32113 is disposed on the first base plate 32111. The first chip module 32113 is electrically connected to each component on the first control submodule 3211 and performs corresponding control on the component.

In an embodiment, the first control submodule 3211 further includes a first power module 32114. The first power module 32114 is disposed on the first base plate 32111. The first power module 32114 may be electrically connected to the first chip module 32113. The first power module 32114 may be electrically connected to other components, such as a memory, different from the first chip module 32113. The first power module 32114 can supply power to other components on the first control submodule 3211.

In an embodiment, the first control submodule 3211 further includes a plurality of first communicational connection units 32116. The plurality of first communicational connection units 32116 are disposed on the first side plate 32112. The first communicational connection units 32116 are electrically connected to the first chip module 32113, and may be connected to an external device so that the external device can exchange information with the first chip module 32113. The first communicational connection units 32116 may be connected to other modules in the control device 3 so that such modules can exchange information with the first chip module 32113. Optionally, the first communicational connection units 32116 include, but are not limited to, a USB communication interface, an Ethernet interface, a battery management unit power supply/communication interface, a multi-machine synchronization interface, a standard serial port, and a general-purpose interface bus.

In an embodiment, the first control submodule 3211 further includes a first radio unit 32117. The first radio unit 32117 is disposed on the first side plate 32112. The first radio unit 32117 is electrically connected to the first chip module 32113. The first radio unit 32117 may be configured to transmit or receive electromagnetic wave information, thereby improving the efficiency and reliability of the control device 3 in transmitting or receiving information. In an embodiment, the first radio unit 32117 may be configured to transmit the information processed by the first chip module 32113, and receive information and transmit the received information to the first chip module 32113.

In an embodiment, the first control submodule 3211 further includes a first display unit 32118. The first display unit 32118 is disposed on the first side plate 32112. The first display unit 32118 is electrically connected to the first chip module 32113. The first display unit 32118 may be configured to display some information, such as the State of Charge (SOC) and alarm information of the battery cell connected to the control device 3. In an embodiment, the first display unit 32118 may be configured to display relevant information of the first chip module 32113. In some embodiments, the first display unit 32118 includes a SOC indicator 32118a. The SOC indicator 32118a is configured to display the SOC of the battery cell connected to the control device 3. In some embodiments, the first display unit 32118 includes a warning light 32118b. When the first chip module 32113 receives abnormality information (such as a short circuit and high temperature), the warning light 32118b flashes to remind the staff.

In an embodiment, the first control submodule 3211 further includes a first plug-in unit 32119. The first plug-in unit 32119 is disposed on the first base plate 32111. The first plug-in unit 32119 may be configured to be plugged into the first adapter member 3402 on the adapter unit 340. In this way, the first control submodule 3211 can be electrically connected to the first control module 321, the second control submodule 3212, the third control submodule 3213, and the fourth control submodule 3214 through the adapter unit 340.

In an embodiment, the control device 3 further includes a first guide rail 371. The first guide rail 371 is disposed in the first housing 31 extends along the second direction Y. The first guide rail 371 corresponds to the first base plate 32111. The first base plate 32111 coordinates with the first guide rail 371, and can move relative to the first housing 31 along the first guide rail 371. In this way, the first control submodule 3211 moves relative to the first housing 31.

In an embodiment, the first side plate 32112 is detachably connected to the first guide rail 371. After the first side plate 32112 is disconnected from the first guide rail 371, the first control submodule 3211 can be pulled out of the first recess 310 by pulling the first side plate 32112.

Optionally, two first guide rails 371 are disposed. The two first guide rails 371 are disposed opposite to each other along the third direction X, one is disposed on the third wall 313, and the other is disposed between the third wall 313 and the fourth wall 314. The two first guide rails 371 disposed improves the stability of movement of the first control submodule 3211 relative to the first housing 31. Optionally, the first side plate 32112 is detachably connected to the two first guide rails 371 separately by screws.

In an embodiment, the second control submodule 3212 further includes a second base plate 32121. The second base plate 32121 is connected to the second side plate 32122. The second base plate 32121 can slide relative to the first housing 31 along the second direction Y. In this way, the second side plate 32122 can drive the second control submodule 3212 to move out of the first housing 31, so as to facilitate maintenance for the second control submodule 3212.

In an embodiment, the second control submodule 3212 includes a second chip module 32123. The second chip module 32123 is disposed on the second base plate 32121. The second chip module 32123 is electrically connected to each component on the second control submodule 3212 and performs corresponding control on the component.

In an embodiment, the second control submodule 3212 further includes a second power module 32124. The second power module 32124 is disposed on the second base plate 32121. The second power module 32124 may be electrically connected to the second chip module 32123. The second power module 32124 may be electrically connected to other components, such as a memory, different from the second chip module 32123. The second power module 32124 can supply power to other components on the second control submodule 3212.

In an embodiment, the second control submodule 3212 further includes a plurality of second communicational connection units 32126. The plurality of second communicational connection units 32126 are disposed on the second side plate 32122. The second communicational connection units 32126 are electrically connected to the second chip module 32123, and may be connected to an external device so that the external device can exchange information with the second chip module 32123. The second communicational connection units 32126 may be connected to other modules in the control device 3 so that such modules can exchange information with the second chip module 32123. Optionally, each second communicational connection unit 32126 is configured to transmit information processed by the second chip module 32123 to an external device, and transmit information from the external device to the second chip module 32123. Optionally, the second communicational connection units 32126 include, but are not limited to, a USB communication interface, a battery management unit power supply/communication interface, a multi-machine synchronization interface, a standard serial port, and a general-purpose interface bus.

In an embodiment, the second control submodule 3212 further includes a storage connection unit 32127. The storage connection unit 32127 is disposed on the second side plate 32122. The storage connection unit 32127 is electrically connected to the second chip module 32123. The storage connection unit 32127 may be configured to allow insertion of a memory card, so as to exchange information with the second chip module 32123. In an embodiment, the storage connection unit 32127 is configured to transmit information on the memory card to the second chip module 32123, and transmit information processed by the second chip module 32123 to the memory card. Optionally, the storage connection unit 32127 includes an SD card connector.

In an embodiment, the second control submodule 3212 further includes a second plug-in unit 32128. The second plug-in unit 32128 is disposed on the second base plate 32121. The second plug-in unit 32128 may be configured to be plugged into the second adapter member 3403 on the adapter unit 340. In this way, the second control submodule 3212 can be electrically connected to the first control module 321, the first control submodule 3211, the third control submodule 3213, and the fourth control submodule 3214 through the adapter unit 340.

In an embodiment, the control device 3 further includes a second guide rail 372. The second guide rail 372 extends along the second direction Y. The second guide rail 372 corresponds to the second base plate 32121. The second base plate 32121 coordinates with the second guide rail 372, and can move relative to the first housing 31 along the second guide rail 372. In this way, the second control submodule 3212 moves relative to the first housing 31.

In an embodiment, the second side plate 32122 is detachably connected to the second guide rail 372. After the second side plate 32122 is disconnected from the second guide rail 372, the second control submodule 3212 can be pulled out of the first recess 310 by pulling the second side plate 32122.

Optionally, two second guide rails 372 are disposed. The two second guide rails 372 are disposed opposite to each other along the third direction X, one is disposed on the third wall 313, and the other is disposed between the third wall 313 and the fourth wall 314. The two second guide rails 372 disposed improve the stability of movement of the second control submodule 3212 relative to the first housing 31. Optionally, the second side plate 32122 is detachably connected to the two second guide rails 372 separately by screws.

In an embodiment, the third control submodule 3213 further includes a third base plate 32131. The third base plate 32131 is connected to the third side plate 32132. The third base plate 32131 can slide relative to the first housing 31 along the second direction Y. In this way, the third side plate 32132 can drive the third control submodule 3213 to move out of the first housing 31, so as to facilitate maintenance for the third control submodule 3213.

In an embodiment, the third control submodule 3213 includes a third chip module 32133. The third chip module 32133 is disposed on the third base plate 32131. The third chip module 32133 is electrically connected to each component on the third control submodule 3213 and performs corresponding control on the component.

In an embodiment, the third control submodule 3213 further includes a third power module 32134. The third power module 32134 is disposed on the third base plate 32131. The third power module 32134 may be electrically connected to the third chip module 32133. The third power module 32134 may be electrically connected to other components different from the third chip module 32133. The third power module 32134 can supply power to other components on the third control submodule 3213.

In an embodiment, the third control submodule 3213 further includes a voltage control unit 32135. The voltage control unit 32135 is disposed on the third base plate 32131. The voltage control unit 32135 is electrically connected to a battery cell externally connected to the control device 3. The voltage control unit 32135 may be configured to control the voltage input into the battery cell and the voltage output by the battery cell.

In an embodiment, the third control submodule 3213 further includes a third plug-in unit 32136. The third plug-in unit 32136 is disposed on the third base plate 32131. The third plug-in unit 32136 is electrically connected to the voltage control unit 32135. Optionally, the third plug-in unit 32136 is oriented away from the third side plate 32132. Optionally, the third plug-in unit 32136 may be plugged into the adapter unit 340. In this way, the third control submodule 3213 can be electrically connected to the first control module 321, the first control submodule 3211, the second control submodule 3212, and the fourth control submodule 3214 through the adapter unit 340.

In an embodiment, the third control submodule 3213 further includes a photoelectric coupling unit 32138. The photoelectric coupling unit 32138 is disposed on the third base plate 32131. The photoelectric coupling unit 32138 is electrically connected to the third chip module 32133. The photoelectric coupling unit 32138 may be configured to transmit and receive photoelectric signals, and is of high electrical insulativity and high resistance to interference.

In an embodiment, the third control submodule 3213 further includes a first filtering unit 32137. The first filtering unit 32137 is disposed on the third base plate 32131 and electrically connected to the third chip module 32133. The first filtering unit 32137 is configured to filter out electromagnetic radiation pollution in the control device 3, so as to reduce the impact of electromagnetic radiation on each component, for example, to reduce the impact of electromagnetic radiation on the photoelectric coupling unit 32138 and the first radio unit 32117. Optionally, the first filtering unit 32137 includes a common-mode inductor. The common-mode inductor may be configured to filter out common-mode interference.

In an embodiment, the control device 3 further includes a third guide rail 373. The third guide rail 373 extends along the second direction Y. The third guide rail 373 corresponds to the third base plate 32131. The third base plate 32131 coordinates with the third guide rail 373, and can move relative to the first housing 31 along the third guide rail 373. In this way, the third control submodule 3213 moves relative to the first housing 31.

In an embodiment, the third side plate 32132 is detachably connected to the third guide rail 373. After the third side plate 32132 is disconnected from the third guide rail 373, the third control submodule 3213 can be pulled out of the first recess 310 by pulling the third side plate 32132.

Optionally, two third guide rails 373 are disposed. The two third guide rails 373 are disposed opposite to each other along the third direction X, one is disposed on the fourth wall 314, and the other is disposed between the third wall 313 and the fourth wall 314. The two third guide rails 373 disposed improve the stability of movement of the third control submodule 3213 relative to the first housing 31. Optionally, the third side plate 32132 is detachably connected to the two third guide rails 373 separately by screws.

In an embodiment, the fourth control submodule 3214 further includes a fourth base plate 32141. The fourth base plate 32141 is connected to the fourth side plate 32142. The fourth base plate 32141 can slide relative to the first housing 31 along the second direction Y. In this way, the fourth side plate 32142 can drive the fourth control submodule 3214 to move out of the first housing 31, so as to facilitate maintenance for the fourth control submodule 3214.

In an embodiment, the fourth control submodule 3214 includes a fourth chip module 32143. The fourth chip module 32143 is disposed on the fourth base plate 32141. The fourth chip module 32143 is electrically connected to each component on the fourth control submodule 3214 and performs corresponding control on the component.

In an embodiment, the fourth control submodule 3214 further includes a fourth power module 32144. The fourth power module 32144 is disposed on the fourth base plate 32141. The fourth power module 32144 may be electrically connected to the fourth chip module 32143. The fourth power module 32144 may be electrically connected to other components different from the fourth chip module 32143. The fourth power module 32144 can supply power to other components on the fourth control submodule 3214.

In an embodiment, the fourth control submodule 3214 further includes a wireless communication module 32145. The wireless communication module 32145 is disposed on the fourth base plate 32141, and is electrically connected to the fourth chip module 32143. The wireless communication module 32145 may be configured to transmit and receive radio frequency signals, thereby improving the convenience of communication. In an embodiment, the wireless communication module 32145 may be configured to transmit in a wireless manner the information processed by the fourth chip module 32143, and receive information and transmit the received information to the fourth chip module 32143. Optionally, the wireless communication module 32145 includes a radio frequency chip.

In an embodiment, the fourth control submodule 3214 further includes a plurality of detection connection units 32146. The plurality of detection connection units 32146 are disposed on the fourth side plate 32142. The plurality of detection connection units 32146 are electrically connected to a plurality of sensors in the control device 3. Each of the detection connection units 32146 may be connected to an external detection device, so that the detection device can detect the corresponding sensor.

In an embodiment, the control device 3 further includes a fourth guide rail 374. The fourth guide rail 374 extends along the second direction Y. The fourth guide rail 374 corresponds to the fourth base plate 32141. The fourth base plate 32141 coordinates with the fourth guide rail 374, and can move relative to the first housing 31 along the fourth guide rail 374. In this way, the fourth control submodule 3214 moves relative to the first housing 31.

In an embodiment, the fourth side plate 32142 is detachably connected to the fourth guide rail 374. After the fourth side plate 32142 is disconnected from the fourth guide rail 374, the fourth control submodule 3214 can be pulled out of the first recess 310 by pulling the fourth side plate 32142.

Optionally, two fourth guide rails 374 are disposed. The two fourth guide rails 374 are disposed opposite to each other along the third direction X, one is disposed on the fourth wall 314, and the other is disposed between the third wall 313 and the fourth wall 314. The two fourth guide rails 374 disposed improve the stability of movement of the fourth control submodule 3214 relative to the first housing 31. Optionally, the fourth side plate 32142 is detachably connected to the two fourth guide rails 374 separately by screws.

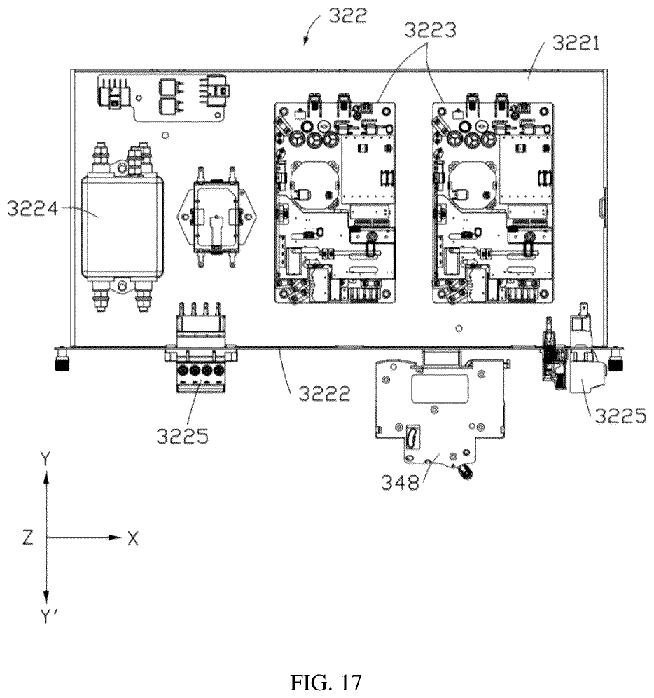

Referring to FIG. 2 and FIG. 17, in an embodiment, the second control module 322 further includes a fifth base plate 3221. The fifth base plate 3221 is connected to the fifth side plate 3222. The fifth base plate 3221 can slide relative to the first housing 31 along the second direction Y. In this way, the fifth side plate 3222 can drive the second control module 322 to move out of the first housing 31, so as to facilitate maintenance for the second control module 322.

In an embodiment, the second control module 322 includes a direct-current power module 3223. The direct-current power module 3223 is disposed on the fifth base plate 3221, and is configured to convert AC power into DC power and provide a constant current for components in the control device 3.

In an embodiment, the second control module 322 further includes a second filtering unit 3224. The second filtering unit 3224 is disposed on the fifth base plate 3221, and is configured to filter out electromagnetic radiation pollution in the control device 3 to reduce the impact of electromagnetic radiation on the components. Optionally, the second filtering unit 3224 includes a filter.

In an embodiment, the second control module 322 further includes a third communicational connection unit 3225. The third communicational connection unit 3225 is disposed on the fifth base plate 3221, and may be connected to an external device so that the external device can exchange information with the second control module 322. As shown in FIG. 8, the third communicational connection unit 3225 extends beyond the first wall 311 along the fourth direction Y′, thereby facilitating connection to an external device through a wire.

In an embodiment, the control device 3 further includes a fifth guide rail 375. The fifth guide rail 375 extends along the second direction Y. The fifth guide rail 375 corresponds to the fifth base plate 3221. The fifth base plate 3221 coordinates with the fifth guide rail 375, and can move relative to the first housing 31 along the fifth guide rail 375. In this way, the second control module 322 moves relative to the first housing 31.

In an embodiment, the fifth side plate 3222 is detachably connected to the fifth guide rail 375. After the fifth side plate 3222 is disconnected from the fifth guide rail 375, the second control module 322 can be pulled out of the first recess 310 by pulling the fifth side plate 3222.

Optionally, two fifth guide rails 375 are disposed. The two fifth guide rails 375 are disposed opposite to each other along the third direction X. The two fifth guide rails 375 disposed improve the stability of movement of the second control module 322 relative to the first housing 31. Optionally, the fifth side plate 3222 is detachably connected to the two fifth guide rails 375 separately by screws.

As shown in FIG. 2, in an embodiment, along the second direction Y, the adapter unit 340 is disposed on one side of the first control submodule 3211, the second control submodule 3212, the third control submodule 3213, the fourth control submodule 3214, and the second control module 322, the side being oriented away from the first wall 311.

When the first control submodule 3211, the second control submodule 3212, the third control submodule 3213, the fourth control submodule 3214, and the second control module 322 are located inside the first recess 310, the first control submodule 3211, the second control submodule 3212, the third control submodule 3213, the fourth control submodule 3214, and the second control module 322 are all contiguous to and electrically connected to the adapter unit 340.

After the third plate 353 is disconnected from the fourth plate 354, the third plate 353 can be removed to perform operation on the first side plate 32112, the second side plate 32122, the third side plate 32132, and the fourth side plate 32142.

After the first side plate 32112 is disconnected from the first plate 3112, the first control submodule 3211 can be disconnected from the adapter unit 340 by pulling the first side plate 32112, and can be taken out from the first housing 31 for maintenance.

After the second side plate 32122 is disconnected from the first plate 3112, the second control submodule 3212 can be disconnected from the adapter unit 340 by pulling the second side plate 32122, and can be taken out from the first housing 31 for maintenance.

After the third side plate 32132 is disconnected from the first plate 3112, the third control submodule 3213 can be disconnected from the adapter unit 340 by pulling the third side plate 32132, and can be taken out from the first housing 31 for maintenance.

After the fourth side plate 32142 is disconnected from the first plate 3112, the fourth control submodule 3214 can be disconnected from the adapter unit 340 by pulling the fourth side plate 32142, and can be taken out from the first housing 31 for maintenance.

After the fourth plate 354 is disconnected from the second plate 352, the fourth plate 354 can be removed to perform operation on the fifth side plate 3222.

After the fifth side plate 3222 is disconnected from the first plate 3112, the second control module 322 can be disconnected from the adapter unit 340 by pulling the fifth side plate 3222, and can be taken out from the first housing 31 for maintenance.

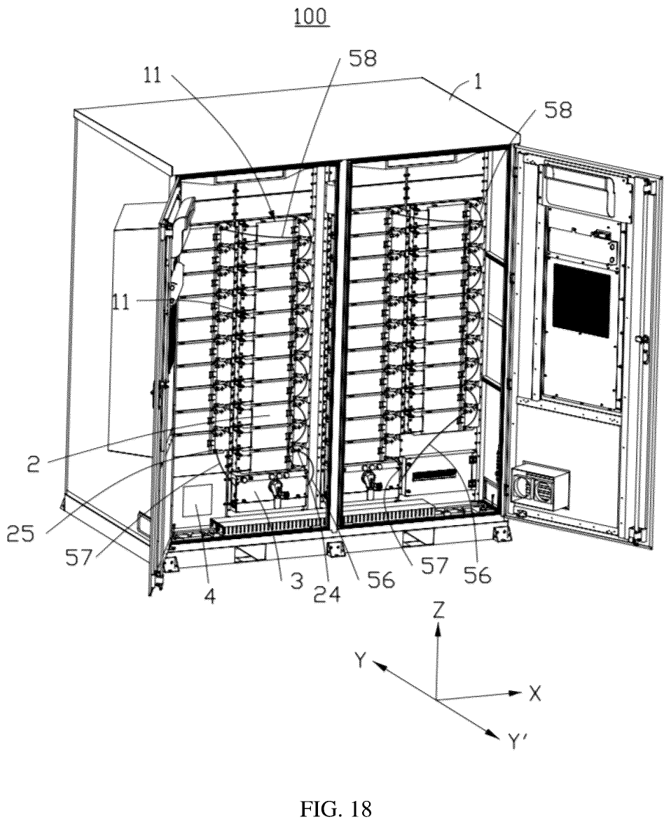

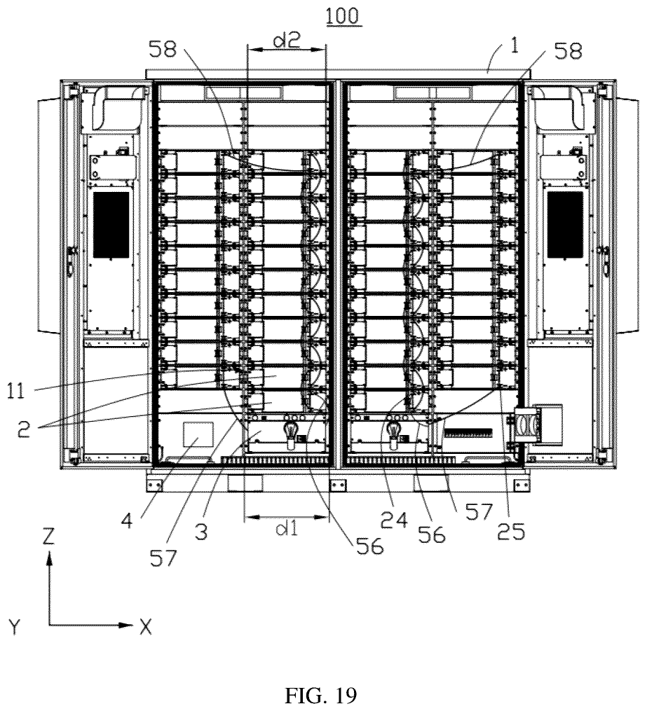

As shown in FIG. 18 and FIG. 19, an embodiment of this application further provides a battery module 100. The battery module 100 includes a second housing 1, a plurality of battery cells 2, and the control device 3 disclosed in any one of the above embodiments. The control device 3 and the plurality of battery cells are disposed in the second housing 1. The plurality of battery cells 2 are electrically connected to the control device 3.

The second housing 1 includes a plurality of accommodation cavity units 11. The control device 3 and the plurality of battery cells 2 are accommodated in different accommodation cavity units 11 respectively. In an embodiment, the plurality of accommodation cavity units 11 are arranged in arrays along the first direction Z and the third direction X.

In an embodiment, a plurality of battery cells 2 and the control device 3 are stacked along the first direction Z.

In an embodiment, along the first direction Z, the control device 3 is disposed between two adjacent battery cells 2.

In an embodiment, along the first direction Z, the control device 3 is disposed at the end of the plurality of stacked battery cells 2.

In an embodiment, the battery module 100 further includes a sixth wire 56 and a seventh wire 57. The sixth wire 56 and the seventh wire 57 may be configured to electrically connect the control device 3 and the battery cells 2.

In an embodiment, the battery module 100 further includes an eighth wire 58. The eighth wire 58 is configured to electrically connect different battery cells 2. In an embodiment, the eighth wire 58 is disposed between adjacent accommodation cavity units 11, thereby implementing hidden wiring, improving neatness, and improving space efficiency in the second housing 1.

In an embodiment, the battery module 100 further includes a power conversion system 4 and a ninth wire (not shown in the drawing). The power conversion system 4 is electrically connected to the control device 3 by the ninth wire.

In an embodiment, the ninth wire is disposed between adjacent accommodation cavity units 11, thereby implementing hidden wiring, improving neatness, and improving space efficiency in the second housing 1.

Along the third direction X, the length of the control device 3 is a first distance d1, and the length of the battery cell 2 is a second distance d2, satisfying: d1 is equal to d2. In this way, the control device 3 and the battery cell 2 can swap position in an accommodation cavity unit 11, thereby improving the space efficiency in the second housing 1, and making the battery module 100 more integrated. As used herein, the term “equal” is a description of an ideal state between two values. In actual production or use, two values being equal may mean that a difference between the two values falls within 0±10%.

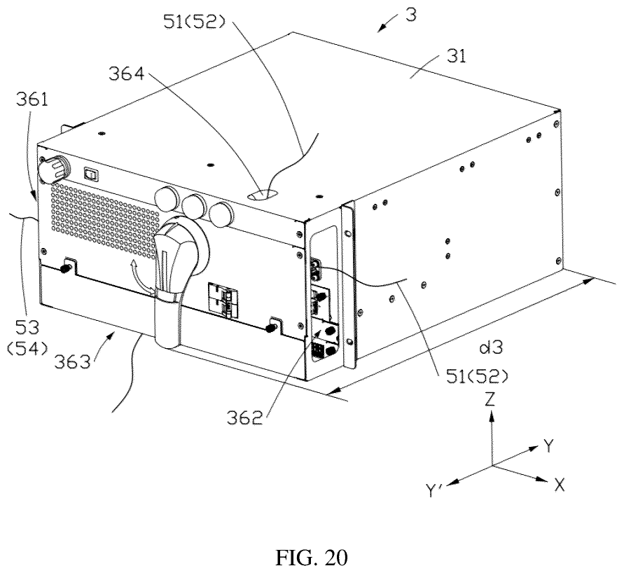

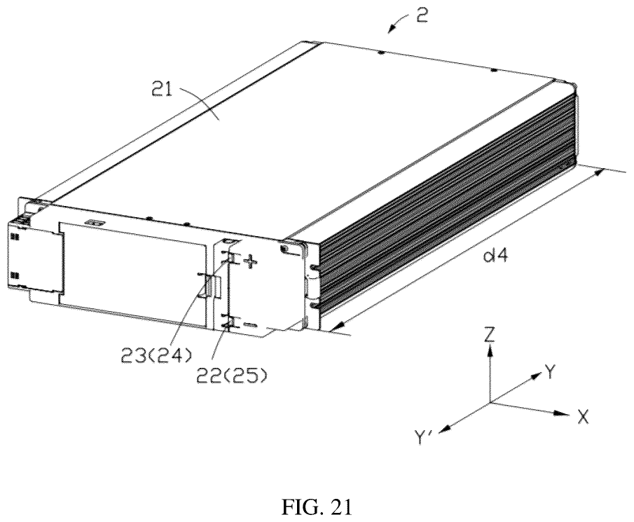

As shown in FIG. 19, FIG. 20, and FIG. 21, along the second direction Y, the length of the control device 3 is a third distance d3, and the length of the battery cell 2 is a fourth distance d4, satisfying: d3 is equal to d4. In this way, the depth of the accommodation cavity unit 11 along the second direction Y can accommodate the control device 3, and can accommodate the battery cell 2 at the same time, thereby improving the space efficiency in the second housing 1 and making the battery module 100 more integrated.

The battery cell 2 includes a battery housing 21, an electrode assembly (not shown in the drawing), a first terminal 22, and a second terminal 23. The electrode assembly is disposed in the battery housing 21. The first terminal 22 and the second terminal 23 are electrically connected to the electrode assembly. The first terminal 22 and the second terminal 23 extend out of the battery housing 21.

In an embodiment, the first terminal 22 and the second terminal 23 are disposed on the same side of the electrode assembly. In some other embodiments, the first terminal 22 may be disposed on one side of the electrode assembly, and the second terminal 23 may be disposed on the other side of the electrode assembly (not shown in the drawing).

The following gives a more detailed description by using an example in which the first terminal 22 and the second terminal 23 are disposed on the same side of the electrode assembly.

Referring to FIG. 3, FIG. 18, FIG. 19, FIG. 20, and FIG. 21, in an embodiment, a third opening 361, a fourth opening 362, a fifth opening 363, and a sixth opening 364 of the control device 3 allow the sixth wire 56 and/or the seventh wire 57 to pass through.

In an embodiment, when a plurality of battery cells 2 and the control device 3 are stacked along the first direction Z, the first terminal 22 and the second terminal 23 are closer to the first wall 311 than to the second wall 312. The first terminal 22, the second terminal 23, and the first control module 321 are all close to the first wall 311, thereby facilitating wiring. In this way, the wires are connected to the first control module 321 through the first wall 311, thereby improving the space efficiency.

The plurality of battery cells 2 are electrically connected to the control device 3 after being connected in series and/or in parallel. In an embodiment, the plurality of battery cells 2 are connected in series and/or in parallel to form a main positive connecting terminal 24 and a main negative connecting terminal 25. Optionally, the main positive connecting terminal 24 is electrically connected to the second connecting member 344 by the sixth wire 56, and the main negative connecting terminal 25 is electrically connected to the third connecting member 345 by the seventh wire 57.

In addition, a person skilled in the art may make other variations to this application without departing from the essence of this application. The variations made based on the essence of this application still fall within the protection scope of this application.

What is claimed is:

1. A control device, comprising a first housing, a first control module, a first conductive path, a second conductive path, a first switch, and a first control member; wherein
the first housing comprises a first recess; the first housing comprises a first wall, a second wall, and a bottom wall; the first wall is disposed opposite to the second wall; the bottom wall is connected to the first wall and the second wall;
the first control module is disposed in the first recess; when viewed along a first direction perpendicular to the bottom wall, the first control module is disposed between the first wall and the second wall; the first control module is closer to the first wall than to the second wall; and the first control module is configured to perform a corresponding control based on a status of an electrically connected battery;
the first conductive path is disposed in the first recess, the first conductive path extends along a second direction perpendicular to the first direction; the first conductive path is contiguous to the first wall; and the first wall is opposite to the second wall along the second direction;
the second conductive path is disposed in the first recess, the second conductive path extends along the second direction; the second conductive path is contiguous to the first wall; and the second conductive path and the first conductive path are spaced apart from each other;
the first switch is disposed in the first recess, the first switch is contiguous to and electrically connected to the first conductive path and the second conductive path; when viewed along the first direction, the first switch and the first control module are spaced apart from each other; and
the first control member is disposed outside the first housing; the first control member is disposed opposite to the first wall along the second direction; and the first control member is connected to the first switch and is configured to control closing and opening of the first switch.

2. The control device according to claim 1, wherein when viewed along the first direction, the first control module overlaps the first conductive path.

3. The control device according to claim 1, wherein when viewed along the first direction, the first control module and the first conductive path are spaced apart from each other.

4. The control device according to claim 1, wherein the control device further comprises a second control module, and the second control module is disposed between the first control module and the first conductive path along the first direction.

5. The control device according to claim 4, wherein the second control module is configured to perform a corresponding conversion on an externally input electrical power.

6. The control device according to claim 5, wherein the second control module is electrically connected to the first control module.

7. The control device according to claim 1, wherein the first control module comprises:
a first control submodule configured to perform the corresponding control based on the status of the electrically connected battery;
a second control submodule configured to perform a corresponding control based on a status of an electrically connected sensor; and
a third control submodule configured to perform insulation monitoring by monitoring a resistance value of the first housing.

8. The control device according to claim 1, wherein the first wall comprises a first opening, the first opening communicates with the first recess, and a gas in the first recess is exchangeable with a gas outside the first housing through the first opening.

9. The control device according to claim 8, wherein the control device further comprises a ventilation member, the ventilation member is disposed on the first wall and opposite to the first opening, and the ventilation member is configured to accelerate exchange between the gas in the first recess and the gas outside the first housing.

10. The control device according to claim 8, wherein the first switch is configured to have a first state and a second state;
when the first switch is in the first state, the first control member overlaps the first opening as viewed along the second direction; and
when the first switch is in the second state, the first control member and the first opening are spaced apart from each other as viewed along the second direction.

11. The control device according to claim 10, wherein in the first state, the first switch is electrically disconnected from the first conductive path and the second conductive path; and
in the second state, the first switch is electrically connected to the first conductive path and the second conductive path.

12. The control device according to claim 1, wherein the control device further comprises a first connecting member, and the first connecting member is connected to the first control member and the first switch.

13. The control device according to claim 1, wherein the first conductive path comprises a first cut-off member and a second cut-off member, the first cut-off member is configured to cut off a connection path of the first conductive path when a current flowing through the first conductive path reaches a first threshold, and the second cut-off member is configured to cut off the connection path of the first conductive path when the current flowing through the first conductive path reaches a second threshold.

14. The control device according to claim 1, wherein the second conductive path comprises a third cut-off member and a fourth cut-off member, the third cut-off member is configured to cut off a connection path of the second conductive path when a current flowing through the second conductive path reaches a third threshold, and the fourth cut-off member is configured to cut off the connection path of the second conductive path when the current flowing through the second conductive path reaches a fourth threshold.

15. A battery module, wherein the battery module comprises:
a second housing;
the control device according to claim 1, disposed in the second housing; and
a plurality of battery cells, disposed in the second housing, wherein the plurality of battery cells are connected to the control device, and the plurality of battery cells and the control device are stacked along the first direction.

16. The battery module according to claim 15, wherein along a third direction perpendicular to the first direction and the second direction, a length of the control device is a first distance, a length of the battery cell is a second distance, and the first distance is equal to the second distance.

17. The battery module according to claim 15, wherein the battery module further comprises a wire, and the wire is electrically connected to the control device and at least one of the battery cells.

18. The battery module according to claim 15, wherein each battery cell comprises an electrode assembly, a first terminal, and a second terminal; the first terminal and the second terminal are disposed on a same side of the electrode assembly and are electrically connected to the electrode assembly; and
along the second direction, the first terminal and the second terminal are closer to the first wall than to the second wall.

19. The battery module according to claim 15, wherein along the first direction, the control device is disposed between two adjacent battery cells.

20. The battery module according to claim 15, wherein along the second direction, a length of the control device is a third distance, a length of the battery cell is a fourth distance, and the third distance is equal to the fourth distance.
